(19) United States
(12) Patent Application Publication
(10) Pub. No.: US 2024/0428211 A1
(43) Pub. Date: Dec. 26, 2024

(54) SYSTEM AND METHOD FOR SUB-MERCHANT FUNDING

(71) Applicant: Worldpay, LLC, Symmes Township, OH (US)

(72) Inventors: Kasturi MUDULODU, Acton, MA (US); Raymond Vincent SMITH, III, Amesburg, MA (US); Kevin Phillip COTTI, Plymouth, MA (US)

(21) Appl. No.: 18/828,689

(22) Filed: Sep. 9, 2024

Related U.S. Application Data
(63) Continuation of application No. 14/965,266, filed on Dec. 10, 2015.

(51) Int. Cl. G06Q 20/08; G06Q 20/10; G06Q 20/22

(52) U.S. Cl. CPC G06Q 20/0855; G06Q 20/10; G06Q 20/227; G06Q 20/2295

(57) ABSTRACT

A computer-implemented payment processing system and method is presented that includes creating a merchant account and a sub-merchant account on a payment processing platform where the merchant account is associated with a payment facilitator and the sub-merchant account is associated with a sub-merchant of the payment facilitator. The payment facilitator charges the sub-merchant a payment facilitation fee to facilitate payment processing on behalf of the sub-merchant. The merchant account and the sub-merchant account are associated with a first settlement account and a second settlement accounts held by a first financial institution and a second financial institution respectively. Subsequent to creating the merchant and sub-merchant account, the system and method processes a payment transaction for an initial amount of funds for the sub-merchant account. The payment facilitation fee is distributed into the first settlement account and the remaining funds are distributed into the second settlement account.

### TECHNICAL FIELD

The systems and methods described below relate generally to the field of deducting and routing fees during transaction processing by a payment processing platform. More particularly, the systems and methods relate to the field of deducting transaction fees during a payment vehicle transaction of a sub-merchant associated with a payment facilitator.

### SUMMARY

A computer-implemented payment processing method includes creating a merchant account and a sub-merchant account on a payment processing platform, where the merchant account is associated with a payment facilitator, and the sub-merchant account is associated with a sub-merchant of the payment facilitator, and where the payment facilitator charges the sub-merchant a payment facilitation fee to facilitate payment processing on behalf of the sub-merchant. The merchant account and the sub-merchant account are associated with a first settlement account and a second settlement account of a first financial institution and a second financial institution respectively. Subsequent to creating the merchant account and the sub-merchant account, the payment processing platform processes a payment transaction for an initial amount of funds originating with the sub-merchant and distributes the payment facilitation fee into the first settlement account and the remaining funds into the second settlement account.

A non-transitory computer readable medium includes instructions stored thereon that when executed by a processor causes the processor to create a merchant account and a sub-merchant account on a payment processing platform, where the merchant account is associated with a payment facilitator, and where the sub-merchant account is associated with a sub-merchant of the payment facilitator, and where the payment facilitator charges the sub-merchant a payment facilitation fee to facilitate payment processing on behalf of the sub-merchant. The merchant account and the sub-merchant account are associated with a first settlement account and a second settlement account of a first financial institution and a second financial institution respectively. Subsequent to creating the merchant account and the sub-merchant account, the instructions process a payment transaction for an initial amount of funds originating with the sub-merchant and distributes the payment facilitation fee into the first settlement account and the remaining funds into the second settlement account.

A payment processing platform includes a means for creating a merchant account and a means for creating a sub-merchant account on the payment processing platform where the merchant account is associated with a payment facilitator, the sub-merchant account is associated with a sub-merchant associated with the payment facilitator, and where the payment facilitator charges the sub-merchant a payment facilitation fee to facilitate payment processing on behalf of the sub-merchant. The payment processing platform includes a means for associating the merchant account with a first settlement account held by a first financial institution and a means for associating the sub-merchant account with a second settlement account held by a second financial institution. The payment processing platform includes a means for processing a payment transaction originating with the sub-merchant for an initial amount of funds. and the payment processing platform includes a means for means for distributing the payment facilitation fee into the first settlement account and a means for distributing the remaining funds into the second settlement account.

### BRIEF DESCRIPTION OF THE DRAWINGS

It is believed that certain embodiments will be better understood from the following description taken in conjunction with the accompanying drawings, in which like references indicate similar elements and in which:

FIG. 1 depicts a block diagram of an example payment processing system.

FIG. 2 depicts an example flow diagram of the system of FIG. 1.

FIG. 3 depicts an example computing device of the system of FIG. 1.

### DETAILED DESCRIPTION

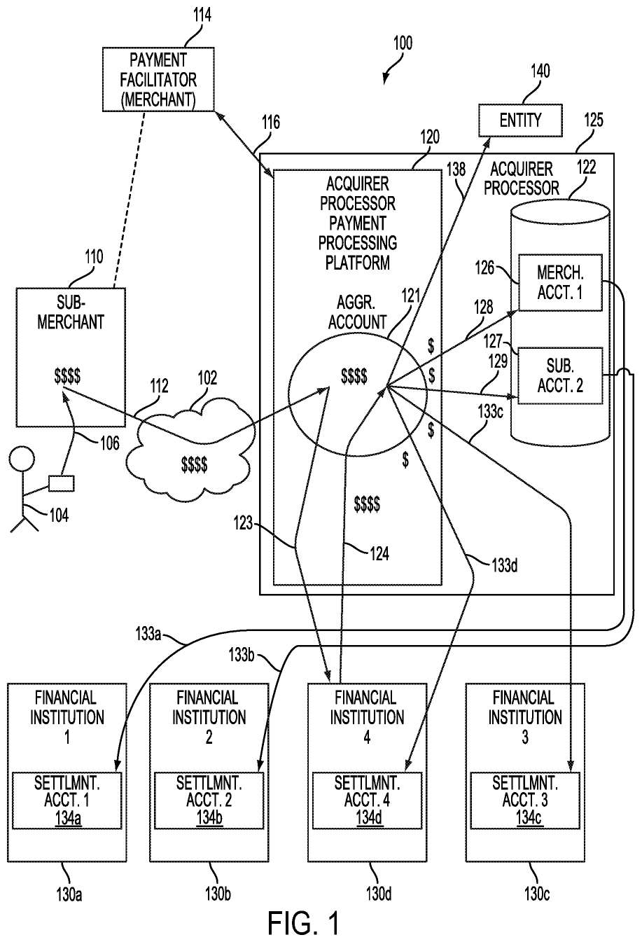

Various non-limiting embodiments of the present disclosure will now be described to provide an overall understanding of the principles of the structure, function, and use of systems and methods disclosed herein for the deduction and routing of various service fees and funds by a payment processing system. The various service fees and funds can be associated with the processing of payment vehicle transactions by payment facilitators, acquirer processors, and financial institutions. One or more examples of these non-limiting embodiments are illustrated in the selected examples disclosed and described in detail with reference made to FIGS. 1-3 in the accompanying drawings. Those of ordinary skill in the art will understand that systems and methods specifically described herein and illustrated in the accompanying drawings are non-limiting embodiments. The features illustrated or described in connection with one non-limiting embodiment may be combined with the features of other non-limiting embodiments. Such modifications and variations are intended to be included within the scope of the present disclosure.

The systems, apparatuses, devices, and methods disclosed herein are described in detail by way of examples and with reference to the figures. The examples discussed herein are examples only and are provided to assist in the explanation of the apparatuses, devices, systems and methods described herein. None of the features or components shown in the drawings or discussed below should be taken as mandatory for any specific implementation of any of these the apparatuses, devices, systems or methods unless specifically designated as mandatory. For ease of reading and clarity, certain components, modules, or methods may be described solely in connection with a specific figure. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such. Any failure to specifically describe a combination or sub-combination of components should not be understood as an indication that any combination or sub-combination is not possible. It will be appreciated that modifications to disclosed and described examples, arrangements, configurations, components, elements, apparatuses, devices, systems, methods, etc. can be made and may be desired for a specific application. Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

Reference throughout the specification to “various embodiments,” “some embodiments,” “one embodiment,” “some example embodiments,” “one example embodiment,” or “an embodiment” means that a particular feature, structure, or characteristic described in connection with any embodiment is included in at least one embodiment. Thus, appearances of the phrases “in various embodiments,” “in some embodiments,” “in one embodiment,” “some example embodiments,” “one example embodiment, or “in an embodiment” in places throughout the specification are not necessarily all referring to the same embodiment. Furthermore, the particular features, structures or characteristics may be combined in any suitable manner in one or more embodiments.

Throughout this disclosure, references to components or modules generally refer to items that logically can be grouped together to perform a function or group of related functions. Like reference numerals are generally intended to refer to the same or similar components. Components and modules can be implemented in software, hardware, or a combination of software and hardware. The term “software” is used expansively to include not only executable code, for example machine-executable or machine-interpretable instructions, but also data structures, data stores and computing instructions stored in any suitable electronic format, including firmware, and embedded software. The terms “information” and “data” are used expansively and includes a wide variety of electronic information, including executable code; content such as text, video data, and audio data, among others; and various codes or flags. The terms “information,” “data,” and “content” are sometimes used interchangeably when permitted by context. It should be noted that although for clarity and to aid in understanding some examples discussed herein might describe specific features or functions as part of a specific component or module, or as occurring at a specific layer of a computing device (for example, a hardware layer, operating system layer, or application layer), those features or functions may be implemented as part of a different component or module or operated at a different layer of a communication protocol stack. Those of ordinary skill in the art will recognize that the systems, apparatuses, devices, and methods described herein can be applied to, or easily modified for use with, other types of equipment, can use other arrangements of computing systems such as client-server distributed systems, and can use other protocols, or operate at other layers in communication protocol stacks, than are described.

For simplicity, the description that follows will be provided by reference to a “payment vehicle,” which generally refers to any type of financial alternative to currency. As is to be clear to those skilled in the art, no aspect of the present disclosure is specifically limited to a specific type of payment vehicle. Therefore, it is intended that the following description encompasses the use of the present disclosure with many other forms of financial alternatives to currency, including credit card, debit cards, smart cards, single-use cards, pre-paid cards, electronic currency (such as might be provided through a cellular telephone or personal digital assistant), and the like. Payment vehicles can be traditional plastic transaction cards, titanium-containing, or other metal-containing, transaction cards, clear and/or translucent transaction cards, foldable or otherwise unconventionally-sized transaction cards, radio-frequency enabled transaction cards, or other types of transaction cards, such as credit, charge, debit, pre-paid or stored-value cards, or any other like financial transaction instrument. A payment vehicle can also have electronic functionality provided by a network of electronic circuitry that is printed or otherwise incorporated onto or within the payment vehicle (and typically referred to as a “smart card”), or be a fob having a transponder and an RFID reader.

FIG. 1 depicts a block diagram of an example payment processing system 100. In the example system 100, a payment vehicle user 104 presents a payment vehicle to a merchant (sub-merchant 110) for payment 106 of goods or services at a point-of-sale terminal associated with the sub-merchant 110. In the illustrated embodiment, the payment vehicle is issued by a financial institution 130d. In some embodiments, the sub-merchant 110 is an online merchant that is configured to accept “card-not-present” transactions. The sub-merchant 110 processes payment vehicle transactions through a payment facilitator 114, sometimes referred to as a payment service provider (PSP). While a single sub-merchant 110 is illustrated in FIG. 1 for simplicity, it is to be appreciated that the payment facilitator 114 can facilitate payment vehicle processing for any number of sub-merchants 110. In some cases, the payment facilitator 114 can facilitate payment vehicle processing for hundreds or thousands of sub-merchants 110.

The payment facilitator 114 uses the payment processing platform 120 of an acquirer processor 125 to process the payment vehicle transactions of the sub-merchant 110. In some embodiments, the payment facilitator 114 is considered the merchant-of-record, as is known in the art. The payment processing platform 120 can route the transactions through a card association network (not shown) and to an issuer to seek authorization for payment transactions originating at the sub-merchant 110. A merchant account 126 is created for the payment facilitator 114 in the payment processing platform 120 of the acquirer processor. The payment facilitator 114 can use an interface 116 to the payment processing platform 120 to create additional sub-merchant accounts for the sub-merchants 110 to which it provides payment facilitation services, such as the sub-merchant account 127 illustrated in FIG. 1. As illustrated in FIG. 1, information associated with the merchant account 126, and the sub-merchant account 127 can be stored in a data store 122 associated with the payment processing platform 120.

The payment vehicle authorization request 112 is sent by the sub-merchant 110 across a network 102 to the payment processing platform 120. As is to be appreciated, the authorization request 112 can be routed through various entities with a payment ecosystem, including the payment facilitator 114. The payment processing platform 120 of the acquirer processor 125 sends a bank authorization request (BAU request 123) for a requested amount of funds to the financial institution 130d that issued the payment vehicle to the payment vehicle user 104. The financial institution 130d sends a bank authorization response (BAU response 124), for example an OK response, to the payment processing platform 120 of the acquirer processor 125 for the amount of the transaction (illustrated, for purposes of exposition only, as “$$$$”.) The sub-merchant 110 can be informed that the payment vehicle transaction is authorized. The payment processing platform 120 electronically credits an aggregated account 121 with the initial amount of funds approved in the BAU response 124 from the financial institution 130d.

Once the funds associated with the transaction of the sub-merchant 110 are in the aggregate account 121, the payment processing platform 120 then settles the funds according one or more settlement rules for that sub-merchant 110 and payment facilitator 114. The settlement of funds can also be based on any fee schedule associated with the financial institution 130d that issued the payment vehicle to the payment vehicle user 104 that was used in the transaction. In some embodiments, various fees can also be provided to third parties associated with the transaction, such as a fulfillment center, or other entities 140.

Example settlement rules can include a service or transaction fee to be deducted from the funds received into the aggregate account 121 and credited 128 to the merchant account 126 associated with the payment facilitator 114. Such fees can be associated, for example, with the payment facilitation services provided to the sub-merchant 110 by the payment facilitator 114, for example a payment facilitation fee. In other words, payment for such services can be provided to the payment facilitator 114 by the payment processing platform 120 as opposed to from the sub-merchant 110. The payment processing platform 120 can deduct the service or transaction fees, for example a payment processing fee, from the funds in the aggregate account 121 prior to distributing the remaining funds (less any other fees) to the sub-merchant account 127. As used herein, the term “fees” generally refers to any type of deduction from the funds, including, without limitation, surcharges, processing fees, garnishments, and so forth.

Service and transaction fees can be based on the requested amount of funds in the BAU response 124, a fixed fee per transaction, or any combination or permutation thereof. The service or transaction fees can be different for each sub-merchant 110 of the payment facilitator 114 or differ by transactions for a sub-merchant 110. The payment facilitator 114 can change the fee structure for each sub-merchant through the interface 116 to the payment processing platform 120. The merchant account 126 can be settled 133a to a first settlement account 134a associated with the payment facilitator 114 at a first financial institution 130a.

The funds associated with the transaction that remain in the aggregate account 121, after all of the payment transaction fees have been deducted by the payment processing platform 120 (sometimes referred to as remaining funds), can be credited 129 to the sub-merchant account 127 associated with the sub-merchant 110. The sub-merchant account 127 can be settled 133b to a second settlement account 134b associated with the sub-merchant 110 at a second financial institution 130b.

The settlement rules can permit other transaction fees to be processed and routed to various entities. For example, the acquirer processor 125 can charge a service or transaction fee, for example the payment processing fee, that also is deducted from the funds in the aggregate account 121. The fee can be settled 133c, or otherwise distributed, to a third settlement account 134c associated with the acquirer processor 125 at a third financial institution 130c. Similarly, the payment processing platform can process payment transaction fees from the funds in aggregate account for a card association (sometimes referred to as interchange fees). For example, a card association associated with the fourth financial institution 130d that issued the payment vehicle used by the payment vehicle user 104 can require payment of a transaction or service fee. The payment can be deducted from the funds in the aggregate account 121 by the payment processing platform 120 and distributed or settled 133d to a fourth settlement account associated with the card association at the fourth financial institution 130d. In some embodiments, fees can be routed 138 by the payment processing platform 120 to an entity 140 on behalf of the sub-merchant 110 and/or the payment facilitator 114. The entity 140 can be, for example, a fulfillment center, a franchisor, a collection agency, an investment bank or other financial institution, a state or federal agency, a service provider, or any other suitable party.

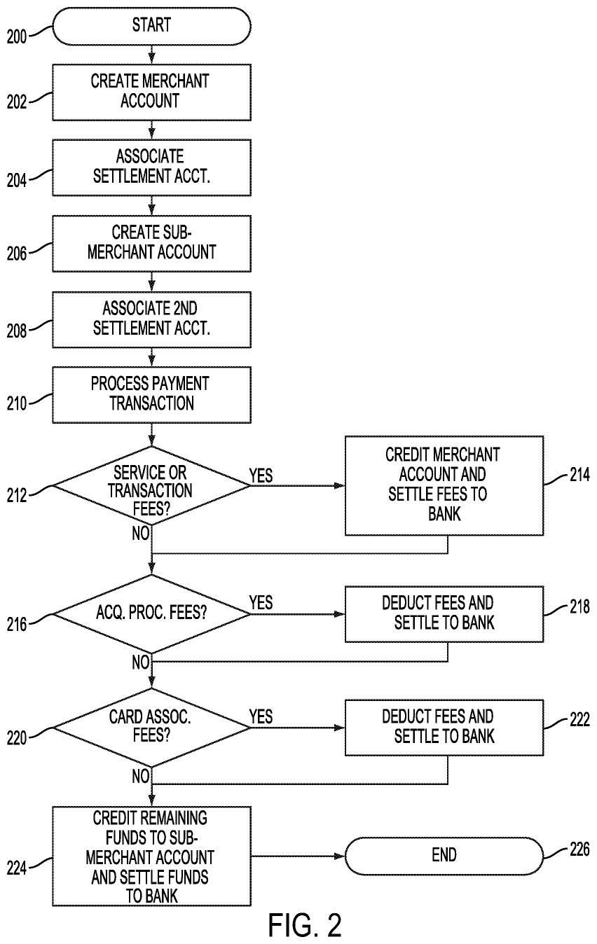

FIG. 2 depicts an example flow diagram of the example system 100 of FIG. 1. Processing begins at start block 200 labeled START, where processes begin executing on a payment processing platform 120 associated with an acquirer processor. Processing continues to process block 202.

In process block 202, a merchant account 126 associated with the payment processing platform 120 and/or the acquirer processor 125 is created for the payment facilitator 114. The payment facilitator 114 can optionally be provided with an interface 116 to the payment processing platform 120 for adding sub-merchants 110 and adjusting service and transaction fees for each sub-merchant. The interface 116 can use hypertext markup language (HTML) and Java scripts, or a dedicated applet or application, or any other suitable interfacing means as would be known or understood in the art. Processing continues to process block 204.

In process block 204, the merchant account 126 is associated with a settlement account 134a for the payment facilitator 114 at a first financial institution 130a. Processing continues to process block 206.

In process block 206, the payment facilitator 114 uses the interface 116 to create a sub-merchant account 127 for a sub-merchant 110 serviced by the payment facilitator 114, or otherwise onboard the sub-merchant 110. One or more settlement rules can be entered by the payment facilitator 114. Processing continues to process block 208.

In process block 208, the sub-merchant account 127 is associated with a second settlement account 134b for the sub-merchant 110 at a second financial institution 130b. Processing continues to process block 210.

In process block 210, the payment processing platform 120 of the acquirer processor 125 processes a payment vehicle transaction associated with the sub-merchant 110. Funds associated with payment vehicle transaction from the issuing financial institution, for example the fourth financial institution 130d, are deposited in the aggregated account 121 of the acquirer processor. Processing continues to decision block 212.

In decision block 212, the settlement rules for the sub-merchant are applied to the payment vehicle transaction and the funds in the aggregated account 121. If the payment facilitator 114 charges a service or transaction fee, the processing continues to process block 214, otherwise processing continues to decision block 216.

In process block 214, the service or transaction fee is determined and the fees are deducted from the aggregate account 121 and credited to the merchant account 126. The fees credited to the merchant account 126 are distributed, or settled, to the first settlement account 134a associated with the payment facilitator 114 at the first financial institution 130a. Processing continues to decision block 216.

In decision block 216, if the acquirer processor 125 charges a service or transaction fee for the transaction, then processing continues to process block 218, otherwise processing continues to decision block 220.

In process block 218, the service or transaction fee for the acquirer processor 125 is deducted from the funds in the aggregate account 121 and distributed, or settled, to the third settlement account 134a associated with the acquirer processor 125 at the third financial institution 130c. In a configuration, the service or transaction fee is deducted from value of funds to be credited to the merchant account 126 in process block 214. In a configuration, the service or transaction fee is deducted from the merchant account 126 of the payment facilitator 114. Processing continues to decision block 220.

In decision block 220, if a card association charges a service or transaction fee for the transaction, then processing continues to process block 222, otherwise processing continues to process block 224.

In process block 222, the service or transaction fee for the card association is deducted from the funds in the aggregate account 121 and settled 133d, or otherwise distributed, to the fourth settlement account 134d associated with the card association at the fourth financial institution 130d. In a configuration, the service or transaction fee is deducted from value of funds to be credited to the merchant account 126 in process block 214. In a configuration, the service or transaction fee is deducted from the merchant account 126 of the payment facilitator 114. Processing continues to process block 224.

In process block 224, the remaining funds in the aggregate account 121 from the payment vehicle transaction are credited to the sub-merchant account 127. The funds credited to the sub-merchant account 127 are distributed, or settled, to the second settlement account 134b associated with the sub-merchant 110 at the second financial institution 130b. Processing continues to end block 226.

In end block 226, labeled END, processing terminates. Additional sub-merchant account can be created in accordance with blocks 206-208. Additional credit-card transactions can be processed in accordance with blocks 210-224. Additional fees can be deducted and credited, or routed 138, to various entities 140 similar to the processing illustrated by blocks 212-222.

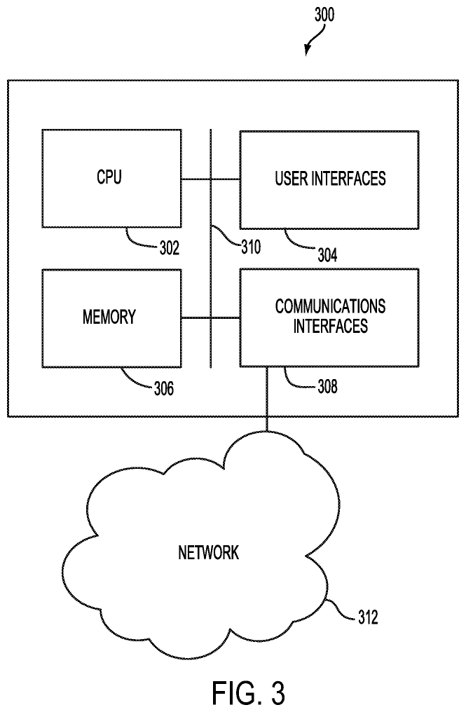

The processes described above can be performed on or between one or more computing devices 300. Referring now to FIG. 3, an example computing device 300 is presented. A computing device 300 can be a server, a computing device that is integrated with other systems or subsystems, a mobile computing device, a cloud-based computing capability, and so forth. The computing device 300 can be any suitable computing device as would be understood in the art, including without limitation, a custom chip, an embedded processing device, a tablet computing device, a point of sale terminal associated with a sub-merchant 110, a back office system of a sub-merchant 110, a personal data assistant (PDA), a desktop, a laptop, a microcomputer, a minicomputer, a server, a mainframe, or any other suitable programmable device. In various embodiments disclosed herein, a single component can be replaced by multiple components and multiple components can be replaced by a single component to perform a given function or functions. Except where such substitution would not be operative, such substitution is within the intended scope of the embodiments.

The computing device 300 includes a processor 302 that can be any suitable type of processing unit, for example a general purpose central processing unit (CPU), a reduced instruction set computer (RISC), a processor that has a pipeline or multiple processing capability including having multiple cores, a complex instruction set computer (CISC), a digital signal processor (DSP), an application specific integrated circuits (ASIC), a programmable logic devices (PLD), and a field programmable gate array (FPGA), among others. The computing resources can also include distributed computing devices, cloud computing resources, and virtual computing resources in general.

The computing device 300 also includes one or more memories 306, for example read only memory (ROM), random access memory (RAM), cache memory associated with the processor 302, or other memories such as dynamic RAM (DRAM), static ram (SRAM), programmable ROM (PROM), electrically erasable PROM (EEPROM), flash memory, a removable memory card or disk, a solid state drive, and so forth. The computing device 300 also includes storage media such as a storage device that can be configured to have multiple modules, such as magnetic disk drives, floppy drives, tape drives, hard drives, optical drives and media, magneto-optical drives and media, compact disk drives, Compact Disk Read Only Memory (CD-ROM), Compact Disk Recordable (CD-R), Compact Disk Rewriteable (CD-RW), a suitable type of Digital Versatile Disk (DVD) or BluRay disk, and so forth. Storage media such as flash drives, solid state hard drives, redundant array of individual disks (RAID), virtual drives, networked drives and other memory means including storage media on the processor 302, or memories 306 are also contemplated as storage devices. It can be appreciated that such memory can be internal or external with respect to operation of the disclosed embodiments. It can be appreciated that certain portions of the processes described herein can be performed using instructions stored on a computer-readable medium or media that direct a computer system to perform the process steps. Non-transitory computer-readable media, as used herein, comprises all computer-readable media except for transitory, propagating signals.

Network and communication interfaces 308 can be configured to transmit to, or receive data from, other computing devices 300 across a network 312. The network and communication interfaces 308 can be an Ethernet interface, a radio interface, a Universal Serial Bus (USB) interface, or any other suitable communications interface and can include receivers, transmitter, and transceivers. For purposes of clarity, a transceiver can be referred to as a receiver or a transmitter when referring to only the input or only the output functionality of the transceiver. Example communication interfaces 308 can include wired data transmission links such as Ethernet and TCP/IP. The communication interfaces 308 can include wireless protocols for interfacing with private or public networks 312. For example, the network and communication interfaces 308 and protocols can include interfaces for communicating with private wireless networks 312 such as a WiFi network, one of the IEEE 802.11x family of networks, or another suitable wireless network. The network and communication interfaces 308 can include interfaces and protocols for communicating with public wireless networks 312, using for example wireless protocols used by cellular network providers, including Code Division Multiple Access (CDMA) and Global System for Mobile Communications (GSM). A computing device 300 can use network and communication interfaces 308 to communicate with hardware modules such as a database or data store, or one or more servers or other networked computing resources. Data can be encrypted or protected from unauthorized access.

In various configurations, the computing device 300 can include a system bus 310 for interconnecting the various components of the computing device 300, or the computing device 300 can be integrated into one or more chips such as programmable logic device or application specific integrated circuit (ASIC). The system bus 310 can include a memory controller, a local bus, or a peripheral bus for supporting input and output devices 304, and communication interfaces 308. Example input and output devices 304 include keyboards, keypads, gesture or graphical input devices, motion input devices, touchscreen interfaces, one or more displays, audio units, voice recognition units, vibratory devices, computer mice, and any other suitable user interface.

The processor 302 and memory 306 can include nonvolatile memory for storing computer-readable instructions, data, data structures, program modules, code, microcode, and other software components for storing the computer-readable instructions in non-transitory computer-readable mediums in connection with the other hardware components for carrying out the methodologies described herein. Software components can include source code, compiled code, interpreted code, executable code, static code, dynamic code, encrypted code, or any other suitable type of code or computer instructions implemented using any suitable high-level, low-level, object-oriented, visual, compiled, or interpreted programming language.

These and other embodiments of the systems and methods can be used as would be recognized by those skilled in the art. The above descriptions of various systems and methods are intended to illustrate specific examples and describe certain ways of making and using the systems disclosed and described here. These descriptions are neither intended to be nor should be taken as an exhaustive list of the possible ways in which these systems can be made and used. A number of modifications, including substitutions of systems between or among examples and variations among combinations can be made. Those modifications and variations should be apparent to those of ordinary skill in this area after having read this disclosure.

1.-20. (canceled)

21. A system of an acquirer processor, the system comprising:
a database configured to store information associated with a first merchant account and a second merchant account, the information including a settlement rule for settling a payment vehicle transaction associated with the second merchant account from a first entity associated with the first merchant account;
one or more processors; and
a memory storing instructions, which when executed by the one or more processors cause the one or more processors to, at least:
receive, via a user interface, the settlement rule for settling the payment vehicle transaction associated with the second merchant account from the first entity associated with the first merchant account;
receive a payment vehicle authorization request for a first transaction from a point-of-sale terminal, based on a payment vehicle being presented to a second entity at the point-of-sale terminal by a payment vehicle user;
send a bank authorization request to a first financial institution associated with the payment vehicle;
receive a bank authorization response from the first financial institution for the first transaction, the authorization response including an authorized amount of the first transaction;
electronically credit an aggregate account of the acquirer processor with the amount included in the bank authorization response;
electronically update a first value amount associated with the first merchant account to credit a first amount in the aggregate account to the first merchant account in the database using the settlement rule;
electronically update a second value amount associated with the second merchant account to credit a second amount in the aggregate account to the second merchant account in the database using the settlement rule;
electronically update a third value amount associated with a first settlement account to distribute the first amount in the first merchant account to the first settlement account of the first entity at a second financial institution; and
electronically update a fourth value amount associated with a second settlement account to distribute the second amount in the second merchant account to the second settlement account of the second entity at a third financial institution.

22. The system of claim 21, wherein the one or more processors are further configured to:
associate the first merchant account stored in the database with the first settlement account of the first entity at the second financial institution.

23. The system of claim 21, wherein the one or more processors are further configured to:
associate the second account stored in the database with the second settlement account of the second entity at the third financial institution.

24. The system of claim 21, wherein the one or more processors are further configured to:
electronically update a fifth value amount associated with a third settlement account of the acquirer processor at a fourth financial institution.

25. The system of claim 21, wherein the one or more processors are further configured to:
adjust the settlement rule based on an input received via the user interface.

26. The system of claim 21, wherein the one or more processors are further configured to:
receive settlement rules corresponding to respective second entities associated with first entity; and
settle payment vehicle transactions of the respective second entities using the settlement rules.

27. The system of claim 21, wherein the one or more processors are further configured to:
distribute a third amount in the aggregate account to a third entity based on the settlement rule received via the user interface.

28. A method comprising:
receiving, from a database, information associated with a first merchant account and a second merchant account, the information including a settlement rule for settling a payment vehicle transaction associated with the second merchant account from a payment facilitator associated with the first merchant account;
receiving, via a user interface, the settlement rule for settling the payment vehicle transaction associated with the second merchant account from the payment facilitator associated with the first merchant account;
receiving a payment vehicle authorization request for a first transaction from a point-of-sale terminal, based on a payment vehicle being presented to a sub-merchant at the point-of-sale terminal by a payment vehicle user;
sending a bank authorization request to a first financial institution associated with the payment vehicle;
receiving a bank authorization response from the first financial institution for the first transaction, the authorization response including an authorized amount of the first transaction;
electronically crediting an aggregate account of the acquirer processor with the amount included in the bank authorization response;
electronically updating a first value amount associated with the first merchant account to credit a first amount in the aggregate account to the first merchant account in the database using the settlement rule;
electronically updating a second value amount associated with the second merchant account to credit a second amount in the aggregate account to the second merchant account in the database using the settlement rule;
electronically updating a third value amount associated with a first settlement account to distribute the first amount in the first merchant account to the first settlement account of the payment facilitator at a second financial institution; and
electronically updating a fourth value amount associated with a second settlement account to distribute the second amount in the second merchant account to the second settlement account of the sub-merchant at a third financial institution.

29. The method of claim 28, further comprising:
associating the first merchant account stored in the database with the first settlement account of the first entity at the second financial institution.

30. The method of claim 28, further comprising:
associating the second account stored in the database with the second settlement account of the sub-merchant at the third financial institution.

31. The method of claim 28, further comprising:
electronically updating a fifth value amount associated with a third settlement account of the acquirer processor at a fourth financial institution.

32. The method of claim 28, further comprising:
adjusting the settlement rule based on an input received via the user interface.

33. The method of claim 28, further comprising:
receiving settlement rules corresponding to respective second entities associated with the payment facilitator; and
settling payment vehicle transactions of the respective second entities using the settlement rules.

34. The method of claim 28, further comprising:
distributing a third amount in the aggregate account to a third entity based on the settlement rule received via the user interface.

35. A non-transitory computer-readable medium storing instructions that, when executed by one or more processors, cause the one or more processors to:
receive, from a database, information associated with a first merchant account and a second merchant account, the information including a settlement rule for settling a payment vehicle transaction associated with the second merchant account from a first entity associated with the first merchant account;
receive, via a user interface, the settlement rule for settling the payment vehicle transaction associated with the second merchant account from the first entity associated with the first merchant account;
receive a payment vehicle authorization request for a first transaction from a point-of-sale terminal, based on a payment vehicle being presented to a second entity at the point-of-sale terminal by a payment vehicle user;
send a bank authorization request to a first financial institution associated with the payment vehicle;
receive a bank authorization response from the first financial institution for the first transaction, the authorization response including an authorized amount of the first transaction;
electronically credit an aggregate account of the acquirer processor with the amount included in the bank authorization response;
electronically update a first value amount associated with the first merchant account to credit a first amount in the aggregate account to the first merchant account in the database using the settlement rule;
electronically update a second value amount associated with the second merchant account to credit a second amount in the aggregate account to the second merchant account in the database using the settlement rule;
electronically update a third value amount associated with a first settlement account to distribute the first amount in the first merchant account to the first settlement account of the first entity at a second financial institution; and
electronically update a fourth value amount associated with a second settlement account to distribute the second amount in the second merchant account to the second settlement account of the second entity at a third financial institution.

36. The non-transitory computer-readable medium of claim 35, wherein the instructions further cause the one or more processors to:
associate the first merchant account stored in the database with the first settlement account of the first entity at the second financial institution.

37. The non-transitory computer-readable medium of claim 35, wherein the instructions further cause the one or more processors to:
associate the second account stored in the database with the second settlement account of the second entity at the third financial institution.

38. The non-transitory computer-readable medium of claim 35, wherein the instructions further cause the one or more processors to:
electronically update a fifth value amount associated with a third settlement account of the acquirer processor at a fourth financial institution.

39. The non-transitory computer-readable medium of claim 35, wherein the instructions further cause the one or more processors to:
adjust the settlement rule based on an input received via the user interface.

40. The non-transitory computer-readable medium of claim 35, wherein the instructions further cause the one or more processors to:
receive settlement rules corresponding to respective second entities associated with first entity; and
settle payment vehicle transactions of the respective second entities using the settlement rules.
